(19) United States
(12) Patent Application Publication
(10) Pub. No.: US 2026/0337518 A1
(43) Pub. Date: Oct. 29, 2026

(54) SYNTHETIC MONO-UNSATURATED TRIGLYCERIDES AND THEIR MONO OR DIALKYL ESTER ANALOGS

(71) Applicant: BIOACCELERGY VENTURES CORPORATION, Houston, TX (US)

(72) Inventors: Rocco A. FIATO, Basking Ridge, NJ (US); John M WRIGHT, Owensboro, KY (US)

(21) Appl. No.: 19/115,957

(22) PCT Filed: Oct. 2, 2023
(86) PCT No.: PCT/US2023/034263

§ 371 Date: Mar. 27, 2025

Related U.S. Application Data
(60) Provisional application No. 63/412,621, filed on Oct. 3, 2022.

(51) Int. Cl. C11C 3/12; C11C 1/04

(52) U.S. Cl. CPC C11C 3/123; C11C 1/04

(57) ABSTRACT

Primarily monounsaturated triglyceride-containing, biologically-derived oils and methods for producing them from triglyceride-containing seed oils are produced by converting polyunsaturated triglyceride feedstocks into mono-unsaturated free fatty acids or fatty acid esters. Methods and systems for processing polyunsaturated triglyceride feeds, or their mono or dialkyl ester analogs, into feedstocks wherein the content of doubly and triply unsaturated alkyl chains has been minimized and the content of monounsaturated alkyl chains has been maximized.

### PRIORITY TO RELATED APPLICATIONS

This application claims priority from U.S. Provisional Application Ser. No. 63/412,621, filed on Oct. 3, 2022, the contents of which are expressly incorporated herein by reference.

### FIELD OF THE INVENTION

This invention relates generally to methods and systems for efficiently making monounsaturated triglycerides and their mono or dialkyl ester analogs from polyunsaturated precursors.

All publications, patents, patent applications, and other references cited in this application are incorporated herein by reference in their entirety for all purposes and to the same extent as if each individual publication, patent, patent application or other reference was specifically and individually indicated to be incorporated by reference in its entirety for all purposes. Citation of a reference herein shall not be construed as an admission that such is prior art to the present invention.

### BACKGROUND

Almost all commercial current day non-GMO triglyceride based oils contain significant levels of doubly or triply unsaturated alkyl moieties. The presence of these structures in the triglyceride or mono or dialkyl-ester analogs has a direct effect on the types of molecules that can be produced in further catalytic processing of these feeds into various renewable chemicals, fuels or lubricants.

It would be desirable to have a means of converting these polyunsaturated feedstocks selectively into mono-unsaturated analogs in an efficient and cost-effective manner.

### SUMMARY OF THE INVENTION

The present invention is directed to methods and systems for processing polyunsaturated triglyceride feeds, or their mono or dialkyl ester analogs, into feedstocks wherein the content of doubly and triply unsaturated alkyl chains has been minimized and the content of monounsaturated alkyl chains has been maximized.

A key aspect of the present invention is directed to methods and systems for processing triglyceride-containing, biologically-derived oils, comprising the conversion of triglycerides to >75% monounsaturated free fatty acids (FFA's) or free fatty acid esters (FFAE's) in a highly selective conversion process, and the separation of the monounsaturated FFA's or FFAE's from other byproducts, such as complex oxygenates, for further conversion to distillate or lubricant range hydrocarbons.

The step of providing a >75% monounsaturated triglyceride feedstock includes partially hydrogenating a triglyceride-containing, biologically-derived oil to the extent necessary to eliminate doubly or triply unsaturated alkyl chains but to retain/selectively convert them into >75% monounsaturated chains.

If the triglyceride-containing, biologically-derived oil comprises primarily Camelina, it is possible to isolate a fraction of free fatty acids formed by the hydrolysis and/or transesterification step having a greater than 75% wt C22:1 carbon chains.

In some embodiments, the method of the invention involves (a) providing a quantity of biologically-derived oil comprising triglycerides; (b) processing the oil to hydrolyze at least some of the triglycerides and form FFA's or FFAE's therefrom, which are primarily monounsaturated C16 and/or C14 FFA's or FFAE's.

In a specific embodiment of the present invention, the triglyceride-containing, biologically-derived oil, is processed by (1) a treating the triglyceride feedstock to a controlled hydrogenation process to selectively hydrogenate the di and tri unsaturated analogs while leaving the mono unsaturated analogs intact, (2) subjecting the triglyceride to a conversion in a transesterification unit for treating the biologically-derived oil (bio-oil) to esterify the triglycerides contained therein, thereby forming free fatty acid esters (FFAE's); (3) isolating the predominately monounsaturated fatty acid esters; (4) subjecting the esters to a selective hydrogenation step.

The foregoing has outlined rather broadly the features of the present invention in order that the detailed description of the invention that follows may be better understood. Additional aspects and advantages of the invention are described in the following detailed description of the invention.

### DETAILED DESCRIPTION OF THE INVENTION

A key aspect of the present invention is directed to methods and systems for processing triglyceride-containing, biologically-derived base oils wherein such processing comprises conversion of triglycerides to monounsaturated FFA's or FFAE's.

A key step in one fully integrated process for the production of lubricants or fuels from a triglyceride feedstock is to control the overall molecular composition of the triglyceride feedstock via genetic selection or modification of conventional seed oil crops to have degree of mono-unsaturation of at least 75% and to limit overall chain length of the free fatty acid backbones. If the triglyceride feedstock has not been genetically selected or modified to be at least 75% mono-unsaturated, the triglyceride feedstock needs to be selectively partially hydrogenated to increase the degree of mono-unsaturation in the FFA backbones to at least 75% while minimizing the formation of fully saturated FFA's. The 75% +mono-unsaturated triglycerides are then hydrolyzed to produce the FFA's as such. Even if the triglyceride feedstock does have a degree of mono unsaturation that is greater than 75%, it is preferable or necessary in many applications to perform the initial selective partial hydrogenating step to further increase the mono-unsaturation content to as high as 90% or more.

The crops triglycerides from which the triglyceride feedstocks are obtained are preferably produced via a carbon farming technique to limit the overall carbon intensity of the renewable oils being produced, and the produced triglyceride feedstocks are preferably subjected to a refining step to limit the overall metals and non-triglyceride content of the oil produced. Refined bleached deodorized (RBD) triglycerides are preferably used as the triglyceride feedstocks in all embodiments described herein in order to avoid negative effects caused by metals content, such as reduce catalyst life.

In one embodiment of the invention, the triglycerides are harvested from seed crops that have been genetically selected or modified such that most of the fatty acids in the triglyceride's from the seeds of a particular crop have the same carbon atom chain length, e.g. C18. Examples of such crops include Plenish High Oleic Soy from Corteva, High Oleic Canola from Perdue, and High Oleic Sunflower from Avril and from genetically enhanced strains in the Ukraine.

### Definitions

Certain terms and phrases are defined throughout this description as they are first used, while certain other terms used in this description are defined below:

The prefix “bio,” as used herein, refers to an association with a renewable resource of biological origin, such resources generally being exclusive of fossil fuels.

A “biologically-derived oil,” as defined herein, refers to any triglyceride-containing oil that is at least partially derived from a biological source such as, but not limited to, crops, vegetables, microalgae, and the like. Such oils may further comprise free fatty acids. The biological source is henceforth referred to as “biomass.”

“Lipids,” as defined herein, broadly refers to the class of molecules comprising fatty acids, and tri-, di-, and monoglycerides.

“Hydrolysis” of triglycerides yields free fatty acids and glycerol, such fatty acid species also commonly referred to as carboxylic acids (see above).

“Transesterification,” or simply “esterification,” refers to the reaction between a fatty acid and an alcohol to yield an ester species.

“Hydroprocessing” refers to processes that react a triglyceride, mono-di or tri-ester derivative of a triglyceride, or a hydrocarbon-based material with hydrogen, typically under pressure and with a catalyst (hydroprocessing can be non-catalytic). Such processes include, but are not limited to, hydrodeoxygenation (of oxygenated species), hydrotreating, hydrocracking, hydroisomerization, hydrofining and hydrodewaxing.

“Isomerizing,” as defined herein, refers to catalytic processes that typically convert n-alkanes to branched isomers.

“Pour point,” as defined herein, represents the lowest temperature at which a fluid will pour or flow. See, e.g., ASTM International Standard Test Methods D 5950-96, D 6892-03, and D 97.

“Cloud point,” as defined herein, represents the temperature at which a fluid begins to phase separate due to crystal formation. See, e.g., ASTM Standard Test Methods D 5773-95, D 2500, D 5551, and D 5771.

Viscosity is the physical property that measures the fluidity of the base stock. Viscosity is a strong function of temperature. Two commonly used viscosity measurements are dynamic viscosity and kinematic viscosity. Dynamic viscosity measures the fluid's internal resistance to flow.

Cold cranking simulator (CCS) viscosity at-35. degree. C. for engine oil is an example of dynamic viscosity measurements. The SI unit of dynamic viscosity is Pas. The traditional unit used is centipoise (cP), which is equal to 0.001 Pas (or 1 m Pas). The industry is slowly moving to SI units. Kinematic viscosity is the ratio of dynamic viscosity to density. The SI unit of kinematic viscosity is mm.sup.2/s. The other commonly used units in industry are centistokes (cSt) at 40. degree. C. (KV40) and 100. degree. C. (KV100) and Saybolt Universal Second (SUS) at 100. degree. F. and 210. degree. F. Conveniently, 1 mm.sup.2/s equals 1 cSt. ASTM D5293 and D445 are the respective methods for CCS and kinematic viscosity measurements.

Viscosity Index (VI) is an empirical number used to measure the change in the base stock's kinematic viscosity as a function of temperature. The higher the VI, the less relative change is in viscosity with temperature. High VI base stocks are desired for most of the lubricant applications, especially in multigrade automotive engine oils and other automotive lubricants subject to large operating temperature variations. ASTM D2270 is a commonly accepted method to determine VI.

Pour point is the lowest temperature at which movement of the test specimen is observed. It is one of the most important properties for base stocks as most lubricants are designed to operate in the liquid phase. Low pour point is usually desirable, especially in cold weather lubrication. ASTM D97 is the standard manual method to measure pour point. It is being gradually replaced by automatic methods, such as ASTM D5950 and ASTM D6749. ASTM D5950 with 1. degree. C. testing interval is used for pour point measurement for the examples in this patent.

Volatility is a measurement of oil loss from evaporation at an elevated temperature. It has become a very important specification due to emission and operating life concerns, especially for lighter grade base stocks. Volatility is dependent on the oil's molecular composition, especially at the front end of the boiling point curve. Noack (ASTM D5800) is a commonly accepted method to measure volatility for automotive lubricants. The Noack test method itself simulates evaporative loss in high temperature service, such as an operating internal combustion engine.

Boiling point distribution is the boiling point range that is defined by the True Boiling Points (TBP) at which 5% and 95% materials evaporates. It is measured by ASTM D2887 herein.

### NMR Branching Analysis

Branching parameters measured by NMR spectroscopy for the hydrocarbon characterization include:

Branching Index (BI): the percentage of methyl hydrogens appearing in the chemical shift range of 0.5 to 1.05 ppm among all hydrogens appearing in the 1H NMR chemical range 0.5 to 2.1 ppm in an isoparaffinic hydrocarbon.

Branching Proximity (BP): the percentage of recurring methylene carbons which are four or more number of carbon atoms removed from an end group or branch appearing at.sup.13C NMR chemical shift 29.8 ppm.

Internal Alkyl Carbons: is the number of methyl, ethyl, or propyl carbons which are three or more carbons removed from end methyl carbons, that includes 3-methyl, 4-methyl, 5+methyl, adjacent methyl, internal ethyl, n-propyl and unknown methyl appearing between.sup.13C NMR chemical shift 0.5 ppm and 22.0 ppm, except end methyl carbons appearing at 13.8 ppm.

5+ Methyl Carbons: is the number of methyl carbons attached to a methine carbon which is more than four carbons away from an end carbon appearing at 13C NMR chemical shift 19.6 ppm in an average isoparaffinic molecule.

The NMR spectra may be acquired using Bruker AVANCE 500 spectrometer using a 5 mm BBI probe. Each sample was mixed 1:1 (wt:wt) with CDCl.sub.3. The.sup.1H NMR was recorded at 500.11 MHz and using a 9.0.mu.s (30.degree.) pulse applied at 4 s intervals with 64 scans co-added for each spectrum. The.sup.13C NMR was recorded at 125.75 MHz using a 7.0.mu.s pulse and with inverse gated decoupling, applied at 6 sec intervals with 4096 scans co-added for each spectrum. A small amount of 0.1 M Cr (acac).sub.3 was added as a relaxation agent and TMS was used as an internal standard.

The branching properties of the lubricant base stock samples of the present invention are determined according to the following six-step process. Procedure is provided in detail in U.S. 20050077208 A1, which reference is incorporated herein in its entirety. The following procedure is slightly modified to characterize the current set of samples: 1) Identify the CH branch centers and the CH.sub.3 branch termination points using the DEPT Pulse sequence (Doddrell, D. T.; D. T. Pegg; M. R. Bendall, Journal of Magnetic Resonance 1982, 48, 323ff.). 2) Verify the absence of carbons initiating multiple branches (quaternary carbons) using the APT pulse sequence (Patt, S. L.; J. N. Shoolery, Journal of Magnetic Resonance 1982, 46, 535ff.). 3) Assign the various branch carbon resonances to specific branch positions and lengths using tabulated and calculated values (Lindeman, L. P., Journal of Qualitative Analytical Chemistry 43, 1971 1245ff; Netzel, D. A., et. al., Fuel, 60, 1981, 307ff.). Branch NMR Chemical Shift (ppm)

It is possible to quantify the relative frequency of branch occurrence at different carbon positions by comparing the integrated intensity of its terminal methyl carbon to the intensity of a single carbon (total integral/number of carbons per molecule in the mixture). For example, number of 5+ methyl branches per molecule is calculated from the signal intensity at a chemical shift of 19.6 ppm relative to intensity of a single carbon. For the unique case of the 2-methyl branch, where both the terminal and the branch methyl occur at the same resonance position, the intensity was divided by two before doing the frequency of branch occurrence calculation. If the 4-methyl branch fraction is calculated and tabulated, its contribution to the 5+ methyls must be subtracted to avoid double counting. Unknown methyl branches are calculated from contribution of signals that appear between 5.0 ppm and 22.5 ppm, however not including any additional branches. Calculate the Branching Index (BI) and Branching Proximity (BP) using the calculations described in U.S. Pat. No. 6,090,989, which is incorporated by reference herein in its entirety. Calculate the total internal alkyl branches per molecule by adding up the branches found in steps 3 and 4, except the 2-methyl branches. These branches would include 3-methyl, 4-methyl, 5+ methyl, internal ethyl, n-propyl, adjacent methyl and unknown methyl.

FIMS Analysis: The hydrocarbon distribution of the current invention is determined by FIMS (field ionization mass spectroscopy). FIMS spectra may be obtained on a Waters GCT-TOF mass spectrometer. The samples were introduced via a solid probe, which was heated from about 40.degree. C. to 500.degree. C. at a rate of 50. degree. C. per minute. The mass spectrometer was scanned from m/z 40 to m/z 1000 at a rate of 5 seconds per decade. The acquired mass spectra were summed to generate one averaged spectrum which provides carbon number distribution of paraffins and cycloparaffins containing up to six rings.

### Alkyl Chain Structure and Properties

The structure of the hydrocarbon mixtures derived from the use of this invention herein may be characterized by FIMS and NMR

The hydrocarbon mixture can be classified into a carbon range from based on the carbon number distribution, of C12 to C22 carbons. Generally, about or greater than 95% of the molecules present in each hydrocarbon mixture produced from the mono-unsaturated triglycerides and their free fatty acid or their mono or dialkyl ester analogs have carbon numbers within the specified range. Representative molecular structures for the C12 to C22 range can be defined based on the NMR and FIMS analysis.

The unique branching structure and narrow carbon distribution of the hydrocarbon mixtures produced from the conversion of the mono-unsaturated triglycerides and their free fatty acid or their mono or dialkyl ester analogs by the process of the invention makes them suitable to be used as high-quality synthetic base oils, especially for low-viscosity engine oil applications. The hydrocarbon mixtures exhibit: a KV100<3 cSt; a pour point in the range of −20 to −55.degree. C

The VI for the C12-C22 hydrocarbon mixture is greater than 120 and may be as high as 145-155.

The Pour Point of the hydrocarbon mixture, in one embodiment ranges from 25 to -55.degree. C. and from 35 to −45.degree. C. in another embodiment.

### Triglyceride-Containing Precursors

The method of the invention can include an initial step of obtaining a biologically-derived oil (bio-oil) comprising triglycerides by subjecting biomass to an extraction process to provide a sufficient quantity of bio oil primarily comprising triglycerides. Typically, such an extraction process involves solvent extraction.

The bio-oil can originate from a biomass source such as seed crops, vegetables, microalgae, and combinations thereof. Those of skill in the art will recognize that generally any biological source of lipids can serve as the biomass from which the bio-oil can be obtained. It will be further appreciated that some such sources are more economical and more amenable to regional cultivation, and also that those sources from which food is not derived may be additionally attractive (so as not to be seen as competing with food).

The hydrolysis of the triglycerides can be accomplished using, e.g., well known acid-or base-catalyzed hydrolysis processes, such as, e.g., that described in Logan et al., U.S. Pat. No. 4,218,386, to yield free fatty acids and glycerol.

The above-described methods can further include a step of catalytically isomerizing at least some of the fatty acid derived hydrocarbons to yield an isomerized hydrocarbon mixture. Depending on process conditions, such isomerizing step can result in lubricant base stocks and/or fuels having superior properties relative to those of the non-isomerized paraffinic (alkane) product (although the paraffinic product itself could find use as a lubricant, fuel or other commodity). The isomerizing step can be carried out using an isomerization catalyst such as Pt or Pd on a support such as SAPO-11, SM-3, SSZ-32, ZSM-23, ZSM-22, and similar such supports. The step of isomerizing the paraffinic product can also be accomplished using a Pt or Pd catalyst supported on an acidic support material such as beta or zeolite Y molecular sieves, SiO.sub.2, Al.sub.20.sub.3, SiO2-Al.sub.20.sub.3, and combinations thereof.

The isomerization is typically carried out at a temperature between about 500.degree. F. and about 750.degree. F. The operating pressure is typically 200 to 2000 pounds-force per square inch gauge (psig), and more typically 200 psig to 1000 psig. Hydrogen flow rate is typically 50 to 5000 standard cubic feet/barrel (SCF/barrel).

The isomerizing step may also be conducted by contacting the paraffinic product with a fixed stationary bed of catalyst, with a fixed fluidized bed, or with a transport bed. In one presently contemplated embodiment, a trickle-bed operation is employed, wherein such feed is allowed to trickle through a stationary fixed bed, typically in the presence of hydrogen.

In some embodiments, the isomerized alkane mixture, comprised of hydrocarbons with <C22 total carbon atoms in the molecules, is alternatively used as a transportation fuel or drilling fluid. Typically, when such isomerized alkanes are used as/in a transportation fuel, they are predominately in the range of C6-C18 species. The isomerized alkane mixture can be mixed or admixed with existing transportation fuels in order to create new fuels or to modify the properties of existing fuels. Isomerization and blending can be used to modulate and maintain pour point and cloud point of the fuel, lubricant, or other product at suitable values.

In some of the above-described method embodiments, the hydrotreating steps may involve a hydroprocessing catalyst and a hydrogen-containing environment. In some such embodiments, the hydroprocessing catalyst is selected from the group consisting of cobalt-molybdenum (C—Mo) catalyst, nickel-molybdenum (N—Mo) catalyst, noble metal catalyst, and combinations thereof. Hydroprocessing conditions generally include temperature in the range 350.degree. C.-450.degree. C. and pressure in the range of about 4.8 mPa to about 15.2 mPa. For a general review of hydroprocessing, see, e.g., Rana et al., “A Review of Recent Advances on Process Technologies for Upgrading of Heavy Oils and Residual” Fuel, vol. 86, pp. 1216-1231, 2007. For an example of how triglycerides can be hydroprocessed to yield a paraffinic product, see Craig et al., U.S. Pat. No. 4,992,605.

### Variations

In some embodiments, non-crop sources of triglyceride-containing oil can be mixed or admixed with the biologically-derived oil used herein. Additionally or alternatively, other sources of free fatty acids or free fatty esters (FFAE's) could be similarly utilized.

A method for producing synthetic fluids from produced from the mono-unsaturated triglycerides and their free fatty acid or their mono or dialkyl ester analogs triglycerides, wherein the triglycerides are harvested from genetically modified seed crops in which the fatty acids in the triglycerides from the seeds of a crop have the same carbon atom chain length, preferably C12 up to C18, will produce synthetic fluids that require little or no hydroconversion. The triglycerides are Hydrolyzed to cleave the fatty acids from the glycerol backbone and to hydrodeoxygenate and isomerize the fatty acid esters to form single carbon chain length isoparaffin having a controlled degree of branching with minimum cracking. Controlled mixtures of hydrocarbon components, in which each hydrocarbon component of the mixture has a different single carbon atom chain length, are produced. The relative ratios of the single carbon atom number hydrocarbons in the mixture are selected to optimize the characteristics of the synthetic fluid product for a given application, if the end product is a readily biodegradable hydrocarbon, the severity of the hydrotreatment is controlled such that the degree of cracking is minimized and the isomers generated are primarily monomethyl isoparaffins. If the end product is a jet fuel blend stock, the hydrotreatment is somewhat more severe in order to generate multiple branched isomers that have improved aerobic biodegradability and low temperature properties. The degree of hydrotreatment is controlled to limit the degree of branching in order to preserve the required thermal and oxidative stability properties, their volatility and viscosity, and to minimize cracking.

The use of C14 or C16 FFA or FFAE's, that are fractionated from the original triglyceride and related oxygenateded containing mixtures are preferred because it enables the elimination of a Hydroconversion step to selectively hydrocrack the end product to reduce its overall chain length and to more directly produce molecules in the desired molecular weight range.

### EXAMPLES

### Production of Triglycerides with Ultra High C18:1 Backbones

Refined bleached deodorized (RBD) triglycerides are selectively hydrogenated to form products wherein the C18 mono-unsaturated (C18:1) content of the unsaturated pool of fatty acid ligands is >90% and the total content of fully saturated C18 acids is minimized.

Typical triglyceride starting material has the properties noted below:

| Parameter | Typical | Test Method |
|---|---|---|
| *Color | Max 2 Red, | Lovibond 5 ¼ |
| | Max 20 Yellow | |
| *Color-after heat | Max 3 Red, | Lovibond 5 ¼ |
| stability test | Max 30 Yellow | |
| *Acid | Max 0.1 | |
| *Iodine | 120-143 | |
| *Peroxide | Max 1.0 | |
| *Fatty Acid | | |
| Composition | | |
| C14 and lower | Max 0.5 | FCC |
| C16 | 10.0-12.0% | FCC |
| C18 | 3-5% | FCC |
| C18:1 | 19-27% | FCC |
| C18:2 | 48-56% | FCC |
| C18:3 | 6-10% | FCC |
| C20 and higher | Max 1% | FCC |
| Trans fatty acid | Max 2.0% | |
| content | | |
| Moisture | Max 0.1% | |
| Synergists as | Max 15 ppm | |
| citric acid | | |
| Phosphoric acid | Max 15 ppm | |

The selective hydrogenation of a RBD soy oil (with total Na, K, Ca, Mg and P content at levels <25 ppmw) over a modified Ni/SiO2 catalyst is achieved by operating at controlled conditions: 100-140 °C Rx temp/40-50 psig H2/0.20-0.023 wt % Ni on RBD feed with an 11-12.5% Ni/SiO2 catalyst as described in U.S. Pat. No. 5,258,346 and U.S. Pat. No. 9,045,410 that comprises nickel on a solid silica support, wherein the catalyst has a pore Volume of at least 0.4 ml/g, a TPR peak maximum within the range of 360-420 °C and wherein the catalyst comprises about 10 to about 90 wt % based on the weight of the catalyst, nickel oxide on a refractory SiO2 support. In these runs, H2 is added to a stirred batch reactor on-demand (i.e. to maintain pressure as reactor pressure decreases) until the desired degree of selective hydrogenation of the di and tri-unsaturated moieties in the RBD are hydrogenated—whilst increasing the overall concentration of the mono-unsaturated moieties and minimizing their hydrogenation to fully saturated analogs.

Shown below is a representative graph of the component weight percent content versus iodine value of the fatty acid components of an RBD soy oil for varying degrees of hydrogenation. As seen in the graph, as the degree of hydrogenation increases from right to left, the percentage content of oleic acid in the soy oil increases until it reaches a peak at a value of about 68 and then decreases somewhat; and the percentage content of poly-unsaturates, consisting of the linoleic acid and linolenic acid, decreases from right to left with increasing selective hydrogenation.

Under controlled conditions we have shown that it is possible to achieve total C18:1 concentration levels of >92% in the unsaturated pool of FFA backbone moieties.

### Production of Free Fatty Acids with High C18:1 Content

Hydrolysis of the triglycerides produced in the selective hydrogenation step can be hydrolyzed to produce free fatty acids according to commonly known procedures. The hydrolysis of the triglycerides can be accomplished using, e.g., well known acid-or base-catalyzed hydrolysis processes, such as, e.g., that described in Logan et al., U.S. Pat. No. 4,218,386, to yield free fatty acids and glycerol.

What is claimed is:

1. A method for producing primarily monounsaturated triglyceride-containing, biologically-derived oils, comprising the steps of:
a. selectively hydrogenating a polyunsaturated triglyceride feedstock containing less than 25 ppmw of Na, K, Ca, Mg, and P at temperatures <180 °C and <100 psig and with a catalyst comprising nickel on a solid silica support, wherein said catalyst has a specific pore volume of at least 0.4 ml/g, a TPR peak maximum within the range of 360-420 °C and wherein said catalyst comprises about an 11-12.5% Ni/SiO2 nickel oxide on a refractory SiO2 support. based on the weight of the catalyst, to produce mono-unsaturated analogs;
b. converting such triglyceride feedstock via hydrolysis into free fatty acids via and/or free fatty acid esters via transesterification;
c. optionally selectively hydro-isomerizing the deoxygenated dimers to the minimum degree necessary to reduce the pour point of the produced product to a desired level.

2. The method of claim 1, wherein the hydrolysis is accomplished at an operating pressure between 500 psig and 6000 psig and an operating temperature between 300 and 500 °C for a residence time of five seconds to 15 minutes to cleave the free fatty acids from the glycerin backbone.

3. The method of claim 2, wherein said hydrolysis further acts to separate the free fatty acids from contaminants including salts, metals or minerals, and organic contaminants comprising asphaltenes, high molecular weight polymers or waxes, coke or coke precursors.

4. The method of claim 1, further comprising the step of fractionating the resulting selectively hydrogenated mono-unsaturated FFA's or FFAE's to obtain analogs of a desired carbon chain length range.

5. The method of claim 4, wherein Step a. of claim 1 includes partially hydrogenating a triglyceride-containing, biologically-derived oil to eliminate double or triple unsaturation content to the extent necessary to raise the monounsaturated content of the triglycerides to at least 80% while minimizing the formation of fully saturated content.

6. The method of claim 3, wherein said biologically-derived oils comprise soy, canola or sunflower, or non-food seed oils such as camelina, castor and jatropha.
